(19) United States
(12) Patent Application Publication
(10) Pub. No.: US 2026/0196943 A1
(43) Pub. Date: Jul. 9, 2026

(54) RECTIFIER CIRCUIT AND OPERATING METHOD THEREOF

(71) Applicant: ASMedia Technology Inc., New Taipei City (TW)

(72) Inventor: Chieh-Jui Ho, New Taipei City (TW)

(73) Assignee: ASMedia Technology Inc., New Taipei City (TW)

(21) Appl. No.: 19/059,291

(22) Filed: Feb. 21, 2025

(30) Foreign Application Priority Data
Jan. 3, 2025 (TW) 114100364

(51) Int. Cl. H02M 7/23

(52) U.S. Cl. CPC H02M 7/23

(57) ABSTRACT

A rectifier circuit includes a transistor string, a bias generator, and a first level shifter. The transistor string includes a first transistor and a second transistor coupled in series. The bias generator is coupled to a control terminal of the second transistor, generates a first bias voltage according to a reference voltage and an output voltage of the rectifier circuit, and provides the first bias voltage to the control terminal of the second transistor. The first level shifter is coupled between a control terminal of the first transistor and the control terminal of the second transistor, shifts a voltage level of the first bias voltage to generate a first offset voltage, and provides the first offset voltage to the control terminal of the first transistor.

### CROSS-REFERENCE TO RELATED APPLICATION

This application claims the priority benefit of Taiwan application serial no. 114100364, filed on Jan. 3, 2025. The entirety of the above-mentioned patent application is hereby incorporated by reference herein and made a part of this specification.

### BACKGROUND

### Technical Field

The disclosure relates to a circuit for stabilizing power supply, and particularly relates to a rectifier circuit and an operating method thereof.

### Description of Related Art

The transistors in a rectifier circuit need to operate in the saturation region to work properly, such as filtering power supply noise and performing rectification. In conventional rectifier circuits, transistor channels are turned on by applying a constant bias voltage. Due to the unstable power supply voltage, unstable output voltage of operational amplifier, and unstable output voltage of the rectifier circuit, the operating method cannot ensure that the transistors operate in the saturation region, which may result in poor performance of the rectifier circuit.

### SUMMARY

The disclosure provides a rectifier circuit and an operating method thereof, which may operate in a relatively wide range of power supply voltages and effectively suppress power supply noise.

A rectification circuit of the embodiment of the disclosure includes a transistor string, a bias generator, and a first level shifter. The transistor string includes a first transistor and a second transistor coupled in series. The bias generator is coupled to a control terminal of the second transistor, and generates a first bias voltage according to a reference voltage and an output voltage of the rectifier circuit, and provides the first bias voltage to the control terminal of the second transistor. The first level shifter is coupled between a control terminal of the first transistor and the control terminal of the second transistor, and shifts a voltage level of the first bias voltage to generate a first offset voltage, and provides the first offset voltage to the control terminal of the first transistor.

An embodiment of the disclosure further provides an operating method of a rectifier circuit. The operating method includes: providing a transistor string having a first transistor and a second transistor coupled in series; providing a bias generator to generate a first bias voltage according to a reference voltage and an output voltage of the rectifier circuit; providing the first bias voltage to a control terminal of the second transistor; providing a first level shifter to shift a voltage level of the first bias voltage to generate a first offset voltage; and providing the first offset voltage to a control terminal of the first transistor.

Based on the above, the rectifier circuit and the operating method thereof according to the embodiment of the disclosure use the level shifter to ensure that each transistor in the rectifier circuit operates in the saturation region, so that the output voltage of the rectifier circuit remains stable.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic diagram of a rectifier circuit according to an embodiment of the disclosure.

FIG. 2 is a schematic diagram of a rectifier circuit according to an embodiment of the disclosure.

FIG. 3 is a schematic diagram of a rectifier circuit according to an embodiment of the disclosure.

FIG. 4 is a schematic diagram of a rectifier circuit according to an embodiment of the disclosure.

FIG. 5 is a schematic diagram of a rectifier circuit according to an embodiment of the disclosure.

FIG. 6 is a flowchart of an operating method of a rectifier circuit according to an embodiment of the disclosure.

### DESCRIPTION OF THE EMBODIMENTS

Some embodiments of the disclosure accompanied with the drawings will now be described in detail. In the reference numerals recited in the description below, the same reference numerals shown in different drawings will be regarded as the same or similar elements. These embodiments are only a part of the disclosure and do not disclose all possible implementations of the disclosure. To be more precise, these embodiments are only examples of the appended claims of the disclosure.

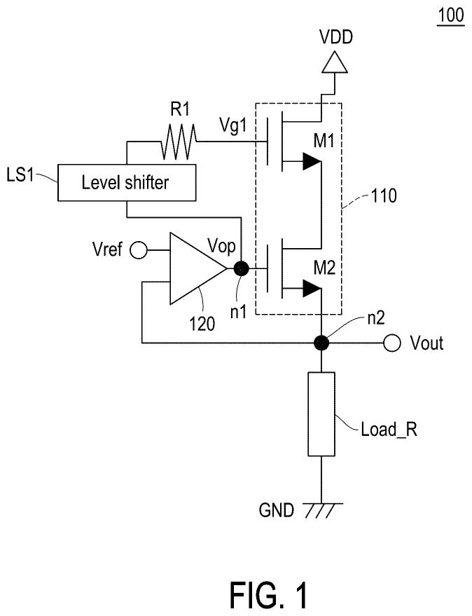

With reference to FIG. 1, FIG. 1 is a schematic diagram of a rectifier circuit 100 according to an embodiment of the disclosure. As shown in FIG. 1, the rectifier circuit 100 includes a transistor string 110, a bias generator 120, and a level shifter LS1. The transistor string 110 includes a transistor M1 and a transistor M2. The transistor M1 and the transistor M2 are coupled to each other in series. In detail, a first terminal of the transistor M1 receives a power supply voltage VDD, a second terminal of the transistor M1 is coupled to a first terminal of the transistor M2, and a second terminal of the transistor M2 forms an output terminal n2 of the rectifier circuit 100 and generates an output voltage Vout.

The bias generator 120 is coupled to a control terminal of the transistor M2 at a node n1. In operation, the bias generator 120 generates a bias voltage Vop according to a reference voltage Vref and the output voltage Vout of the rectifier circuit 100, and provides the bias voltage Vop to the control terminal of the transistor M2. The level shifter LS1 is coupled between a control terminal of the transistor M1 and the control terminal of the transistor M2. In operation, the level shifter LS1 is used to shift a voltage level of the bias voltage Vop to generate an offset voltage Vg1, and provide the offset voltage Vg1 to the control terminal of the transistor M1. The level shifter LS1 is a low-to-high level shifter. In this way, a voltage difference (drain-source voltage) VDS_2 between the first terminal and the second terminal of the transistor M2 may be:

$$VDS\_ 2 = ( Vg 1 - Vop ) - ( Vth 1 - Vth 2 ) \qquad equation ( 1 )$$

wherein Vth1 and Vth2 are the threshold voltages of the transistor M1 and the transistor M2 respectively, and the voltage difference (Vg1−Vop) is related to the offset provided by level shifter LS1. Therefore, the level shifter LS1 may be used to adjust the drain-source voltage of the transistor M2 to ensure that the transistor M2 is operated in the saturation region.

In the embodiment, the bias generator 120 may be an operational amplifier. When the bias generator 120 is an operational amplifier, its coupling method and operating method are as follows. A first input terminal of the operational amplifier is coupled to the output terminal n2 of the rectifier circuit 100. A second input terminal of the operational amplifier receives the reference voltage Vref. An output terminal of the operational amplifier is coupled to the control terminal of the transistor M2 at the node n1 and generates the bias voltage Vop. In some implementations, the first input terminal may be a negative input terminal of the operational amplifier, and the second input terminal may be a positive input terminal of the operational amplifier, that is, the operational amplifier is in a negative feedback state. In the embodiment, the level shifter LS1 may be implemented using a level shift circuit well known to those skilled in the art, and the disclosure is not limited thereto.

In addition, the rectifier circuit 100 may further include a load Load_R. The load Load_R is coupled between the output terminal n2 of the rectifier circuit 100 and a reference ground terminal GND. The reference ground voltage of the reference ground terminal GND is less than the power supply voltage VDD, but is not limited to zero. In the embodiment, the load Load_R may actually be an internal circuit of the rectifier circuit 100.

Incidentally, in the embodiment, the control terminal of the transistor M1 may be coupled to the level shifter LS1 through a resistor R1, and thereby receive the offset voltage Vg1.

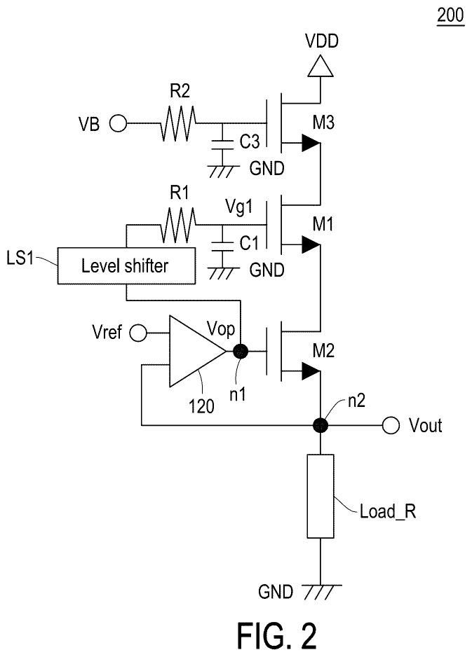

With reference to FIG. 2, FIG. 2 is a schematic diagram of a rectifier circuit 200 according to an embodiment of the disclosure. In addition to the same circuit configuration as the rectifier circuit 100 described above, the transistor string of the rectifier circuit 200 may further include a transistor M3. The transistor M3 is coupled to a path where the transistor M1 receives the power supply voltage VDD, and a control terminal of the transistor M3 may receive a bias voltage VB, where the bias voltage VB may be a constant voltage. In the embodiment, the rectifier circuit 200 may further include a resistor R2 on a path where the control terminal of the transistor M3 receives the bias voltage VB, so that the control terminal of the transistor M3 may receive the bias voltage VB through the resistor R2. In addition, it should be understood that the number of transistors in the transistor string 110 is only an example, and the disclosure is not limited thereto. Those skilled in the art may increase the number of transistors coupled in series in the transistor string 110 according to actual requirements.

In the embodiment, the transistors M1 to M3 may all be N-type transistors.

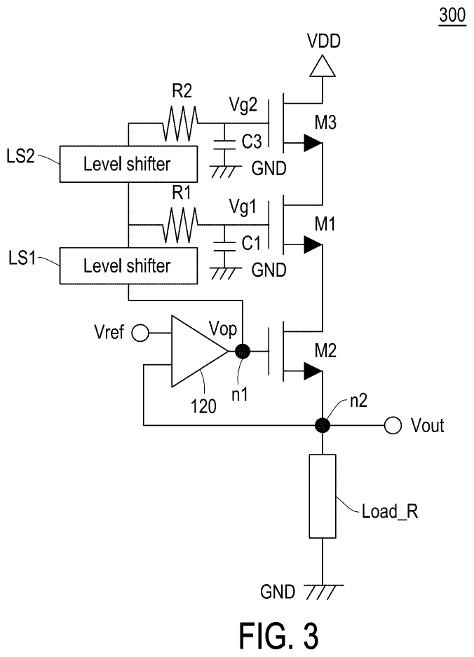

With reference to FIG. 3, FIG. 3 is a schematic diagram of a rectifier circuit 300 according to an embodiment of the disclosure. The rectifier circuit 300 has a similar circuit structure to the rectifier circuit 200 of the previous embodiment, and the same parts will not be repeatedly described herein. It is worth noting that, unlike the rectifier circuit 200, the rectifier circuit 300 further includes a level shifter LS2. As shown in FIG. 3, the level shifter LS2 is coupled between the control terminal of the transistor M1 and the control terminal of the transistor M3. In operation, the level shifter LS2 is used to shift the voltage level of the offset voltage Vg1 to generate an offset voltage Vg2, and provide the offset voltage Vg2 as a bias voltage to the control terminal of the transistor M3. Similar to the level shifter LS1, the level shifter LS2 is a low-to-high level shifter that may be used to adjust the drain-source voltage of the transistor M1 to ensure that the transistor M1 is operated in the saturation region. Incidentally, in the embodiment, the control terminal of the transistor M3 may be coupled to the level shifter LS2 through the resistor R2, and thereby receive the offset voltage Vg2. Other configurations of the rectifier circuit 300 are the same as those of the rectifier circuit 200 and will not be repeatedly described herein.

Incidentally, in the embodiment, the level shifters LS1 and LS2 may provide offsets of the same voltage level, or may provide offsets of different voltage levels respectively, and the disclosure is not limited thereto. The level shifters LS1 and LS2 may have the same circuit architecture.

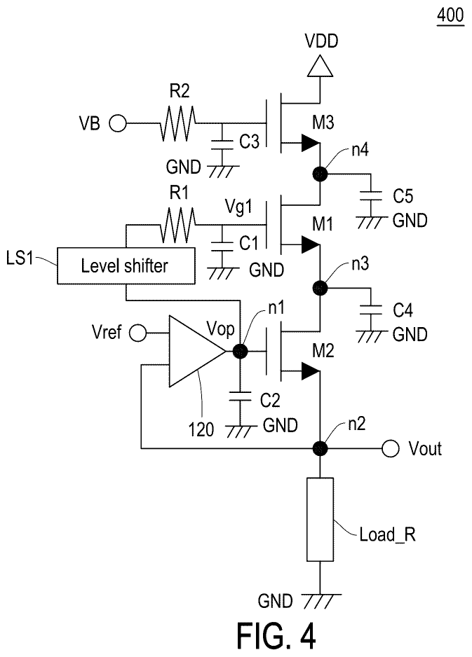

With reference to FIG. 2 and FIG. 4 together, FIG. 4 is a schematic diagram of a rectifier circuit 400 according to an embodiment of the disclosure. In the embodiment of the disclosure, those skilled in the art may selectively couple a capacitor between the control terminal of at least one of the transistors M1, M2, and M3 and the reference ground terminal GND according to actual requirements. In addition to the same circuit configuration as the above-mentioned rectifier circuit 200, in FIG. 4, the rectifier circuit 400 further includes a capacitor C1, a capacitor C2, and a capacitor C3. The capacitor C1, the capacitor C2, and the capacitor C3 are respectively coupled between the control terminals of the transistor M1, the transistor M2, and the transistor M3 and the reference ground terminal GND.

In addition, as shown in FIG. 4, the transistor M1 and the transistor M2 are coupled to each other at a coupling node n3; the transistor M2 and the transistor M3 are coupled to each other at a coupling node n4. Those skilled in the art may also selectively couple a capacitor between at least one of the coupling nodes n3 and n4 and the reference ground terminal GND according to actual requirements. In the embodiment, the rectifier circuit 400 may further include a capacitor C4 and a capacitor C5. The capacitor C4 is coupled between the coupling node n3 and the reference ground terminal GND; and the capacitor C5 is coupled between the coupling node n4 and the reference ground terminal GND. Other configurations of the rectifier circuit 400 are the same as those of the rectifier circuit 200 and will not be repeatedly described herein.

It is worth mentioning that in the embodiment, through the arrangement of the capacitors C2, C4, and C5, the power supply rejection ratio (PSRR) of the rectifier circuit 400 may be effectively improved, thereby reducing the interference caused by the power supply noise on the output voltage Vout.

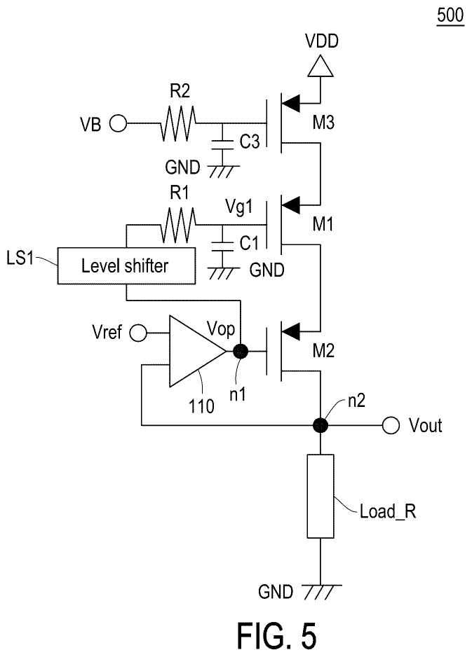

With reference to FIG. 1, FIG. 2, and FIG. 5 together, FIG. 5 is a schematic diagram of a rectifier circuit 500 according to an embodiment of the disclosure. The difference between the rectifier circuit 500 and the rectifier circuit 200 lies in the conductive polarities of the transistors M1 to M3. Other configurations of the rectifier circuit 500 are the same as those of the rectifier circuit 200 and will not be repeatedly described herein.

Different from the rectifier circuit 200, the transistors M1 to M3 in the rectifier circuit 500 may all be P-type transistors.

Incidentally, those skilled in the art may determine the conductive polarity of any of the transistors M1 to M3 in the rectifier circuits 100, 200, and 500 in the aforementioned embodiments according to actual requirements. The transistors (such as transistors M1 to M3) of the transistor string in the embodiment of the disclosure may all have the same conductive polarity, or the transistors (such as transistors M1 to M3) of the transistor string may have different conductive polarities from each other, and the disclosure is not limited thereto.

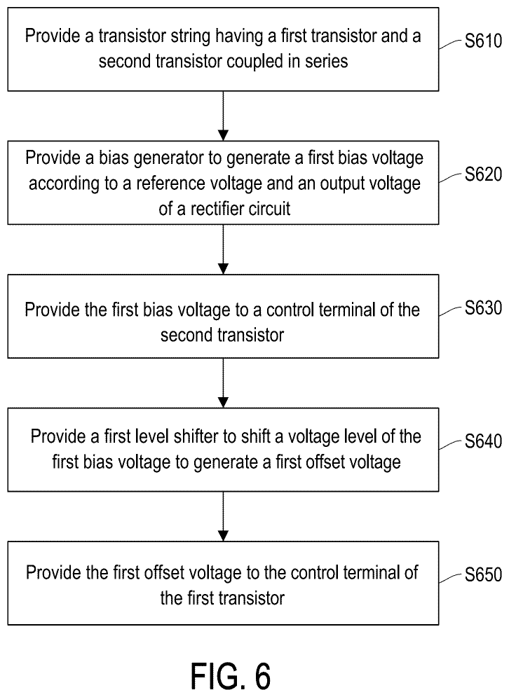

With reference to FIG. 1 and FIG. 6 together, FIG. 6 is a flowchart of an operating method of a rectifier circuit according to an embodiment of the disclosure. The following description will take the rectifier circuit 100 as an example. In step S610, the transistor string 110 having the transistor M1 and the transistor M2 coupled in series is provided; in step S620, the bias generator 120 is provided to generate the bias voltage Vop according to the reference voltage Vref and the output voltage Vout of the rectifier circuit 100; in step S630, the bias voltage Vop is provided to the control terminal of the transistor M2; in step S640, the level shifter LS2 is provided to shift the voltage level of the bias voltage Vop to generate the offset voltage Vg1. In step S650, the offset voltage Vg1 is provided to the control terminal of the transistor M1.

The implementation details of the above steps have been described in detail in the foregoing embodiments and will not be repeatedly described herein.

In summary, the rectifier circuit and the operating method thereof according to the embodiment of the disclosure may ensure that the transistor operates in the saturation region by adding the level shifter. In this way, the rectifier circuit may stably operate under a relatively wide range of power supply voltages, and the ability to suppress power supply noise may be improved and the working range of the rectifier circuit may be increased.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. A rectifier circuit, comprising:
a transistor string, comprising a first transistor and a second transistor coupled in series;
a bias generator, coupled to a control terminal of the second transistor, wherein the bias generator generates a first bias voltage according to a reference voltage and an output voltage of the rectifier circuit, and provides the first bias voltage to the control terminal of the second transistor; and
a first level shifter, coupled between a control terminal of the first transistor and the control terminal of the second transistor, wherein the first level shifter shifts a voltage level of the first bias voltage to generate a first offset voltage, and provides the first offset voltage to the control terminal of the first transistor.

2. The rectifier circuit according to claim 1, wherein the second transistor is coupled in series between the first transistor and an output terminal of the rectifier circuit.

3. The rectifier circuit according to claim 1, wherein the bias generator is an operational amplifier, a first input terminal of the operational amplifier receives the reference voltage, a second input terminal of the operational amplifier receives the output voltage, and an output terminal of the operational amplifier generates the bias voltage.

4. The rectifier circuit according to claim 1, wherein the first transistor and the second transistor have a same conductive polarity.

5. The rectifier circuit according to claim 1, wherein the first transistor and the second transistor are both P-type transistors or N-type transistors.

6. The rectifier circuit according to claim 1, further comprising:
a load, coupled between an output terminal of the rectifier circuit and a reference ground terminal.

7. The rectifier circuit according to claim 1, wherein the transistor string further comprises:
a third transistor, coupled to a path where the first transistor receives a power supply voltage, wherein a control terminal of the third transistor receives a second bias voltage.

8. The rectifier circuit according to claim 7, further comprising:
a second level shifter, coupled between the control terminal of the first transistor and the control terminal of the third transistor, wherein the second level shifter shifts a voltage level of the first offset voltage to generate a second offset voltage, and provides the second offset voltage as the second bias voltage.

9. The rectifier circuit according to claim 7, further comprising:
a plurality of capacitors, respectively coupled between the control terminals of the first transistor, the second transistor, and the third transistor and a reference ground terminal.

10. The rectifier circuit according to claim 7, further comprising:
a plurality of resistors, respectively coupled to the control terminals of the first transistor and the third transistor, wherein the control terminals of the first transistor and the third transistor respectively receive the first offset voltage and the second bias voltage through the resistors.

11. An operating method of a rectifier circuit, comprising:
providing a transistor string having a first transistor and a second transistor coupled in series;
providing a bias generator to generate a first bias voltage according to a reference voltage and an output voltage of the rectifier circuit;
providing the first bias voltage to a control terminal of the second transistor;
providing a first level shifter to shift a voltage level of the first bias voltage to generate a first offset voltage; and
providing the first offset voltage to a control terminal of the first transistor.

12. The operating method according to claim 11, wherein the transistor string further has a third transistor coupled in series with the first transistor, and the method further comprises:
providing a constant second bias voltage to a control terminal of the third transistor.

13. The operating method according to claim 11, wherein the transistor string further has a third transistor coupled in series with the first transistor, and the method further comprises:
providing a second level shifter to shift a voltage level of the first offset voltage to generate a second offset voltage; and
providing the second offset voltage to a control terminal of the third transistor.
